(19) United States
(12) Patent Application Publication
(10) Pub. No.: US 2024/0047986 A1
(43) Pub. Date: Feb. 8, 2024

(54) ELECTRICAL DECOUPLING POWER DELIVERY RESOURCES TO IMPROVE EFFICIENCY OF A LOW POWER STATE

(71) Applicant: Intel Corporation, Santa Clara, CA (US)

(72) Inventors: Ramesh Vankunavath, Bangalore (IN); Shailendra Singh Chauhan, Bengaluru (IN); N.V.S Kumar Srighakollapu, Bengaluru (IN); Ankur Mishra, Bangalore (IN)

(73) Assignee: Intel Corporation, Santa Clara, CA (US)

(21) Appl. No.: 17/881,433

(22) Filed: Aug. 4, 2022

(51) Int. Cl. H02J 7/00

(52) U.S. Cl. CPC H02J 7/00712; H02J 7/0042

(57) ABSTRACT

Techniques and mechanisms for improving an efficiency of power delivery resources. In one embodiment, switch circuitry is operated based on an indication from an integrated circuit (IC) die that circuitry of the IC die is ready to accommodate a low power state which disables a delivery of power to the IC die by a voltage regulator (VR). The switch circuitry is operated, based on a control signal is also used to disable said power delivery, to disable or otherwise prevent one or more conductive paths which are each between a respective two of a battery pack, a voltage regulator, or a battery charger. In another embodiment, the low power state enable a rail for circuitry which is to provide a real time clock signal to the IC die, but disables any other rails which power the IC die.

### BACKGROUND

### 1. Technical Field

This disclosure generally relates to power delivery and more particularly, but not exclusively, to improving the efficiency of a low power system state.

### 2. Background Art

Computing devices such as laptops, netbooks, desktops and servers support one or more low power and/or power saving states. One highly supported power saving standard is defined by the Advanced Configuration and Power Interface (ACPI) Specification, Revision 3.0b, Oct. 10, 1106. In particular, the ACPI Specification defines system power states G0-G3, device power states D0-D1, and processor states C0-C3. The system power state G0 refers to a fully powered system state, the device power state D0 refers to a fully powered device state, and the processor power states C0 refers to a fully-powered operating state. The other power states refer to off states or various levels of reduced power states in which portions of the system, device, and/or processor may be halted or turned-off in order to reduce power consumed by the system, device and/or processor. To take advantage of such lower power states, computing devices may detect periods of system, device, and/or processor inactivity and place such inactive or idle components in a lower power state to conserve energy.

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a system to selectively provide electrical coupling with a battery charger according to an embodiment.

FIG. 2 shows a hybrid block and circuit diagram illustrating features of a system to electrically decouple a battery charger or a voltage regulator from one or more battery cells according to an embodiment.

FIG. 3 shows a hybrid block and circuit diagram illustrating features of a system to electrically decouple a battery charger from a voltage source or a voltage regulator according to an embodiment.

FIG. 4 shows a hybrid block and circuit diagram illustrating features of a system to generate a switch control signal for decoupling a battery charger according to an embodiment.

FIG. 5 shows a hybrid block and circuit diagram illustrating features of a system to electrically decouple a battery charger from other power delivery resources according to an embodiment.

FIG. 6 shows a functional block diagram illustrating features of a computer device to operate a power delivery system according to an embodiment.

### DETAILED DESCRIPTION

Embodiments discussed herein variously provide techniques and mechanisms for improving an efficiency of power delivery resources. Certain features of various embodiments are described herein with reference to the operation of switch circuitry based on an indication from an integrated circuit (IC) die that circuitry of the IC die is ready to accommodate a low power state which disables a delivery of power to the IC die by a voltage regulator (VR). In an embodiment, the switch circuitry is operated based on a control signal is also used to disable said power delivery—e.g., wherein the switch circuitry disables or otherwise prevents one or more conductive paths which are each between a respective two of a battery pack, a voltage regulator, or a battery charger. As a result of such operation by the switch circuitry, some embodiments further reduce power consumption by one or more power delivery resources during the low power state.

The term “low power state” is used herein to distinguish said state from one or more other power states which, in one or more respects, correspond each to a respective higher level of power consumption—e.g., wherein a given other power state enables a delivery of power by the VR to the IC die. In some embodiments, a low power state is a “system state” at least insofar as it comprises a configuration of one or more power delivery resources which are distinguished from (but coupled to) the IC die. For example, such a low power state further comprises a configuration of some or all of the IC die, in some embodiments. As used herein, “electrically decouple,” “electrically decoupling,” “electrically decoupled” and related terms variously refer to the characteristic of a conductive path being disabled or otherwise prevented—e.g., by switch circuitry which is operable to selectively provide either of an electrical decoupling or an electrical coupling between a given two circuit resources.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a circuitry to control an electrical coupling between various resources of a power delivery system.

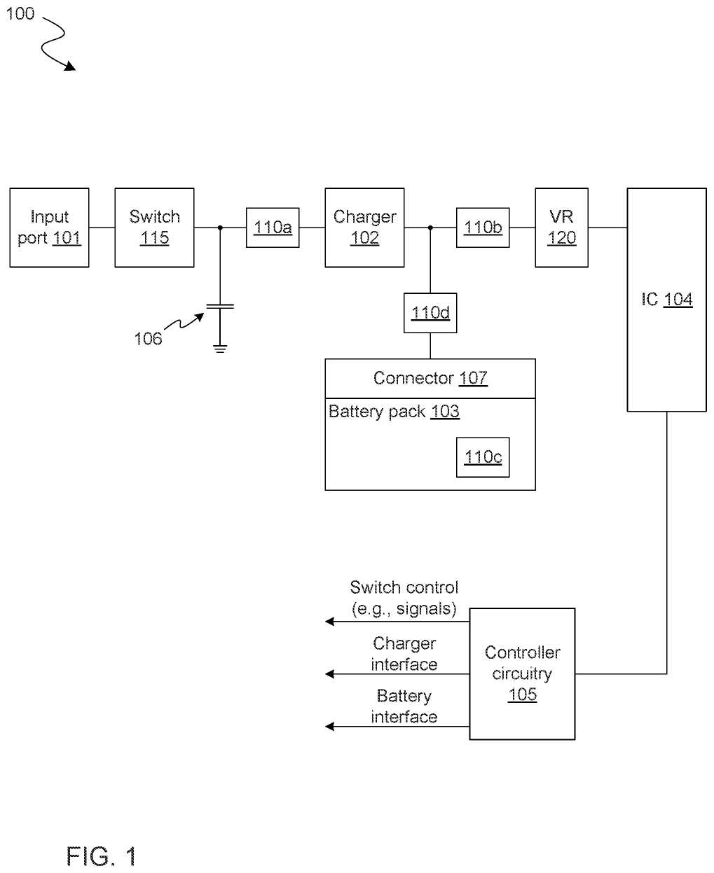

FIG. 1 is a block diagram of a system 100 comprising circuitry to selectively decouple a battery charger from one or more other power delivery resources according to an embodiment. System 100 illustrates one example embodiment wherein one or more switch circuits is operable to selectively disable or otherwise prevent a conductive path between a battery charger and either or both of a battery or a voltage regulator during a low power state during which power delivery by a voltage regulator is disabled. In one such embodiment, the power state provides power via one rail to enable the provisioning of a real time clock to an IC die—e.g., while any other rail to power the IC die is disabled.

Referring to FIG. 1, a charger 102 provides power to a system load—such as the illustrative integrated circuit (IC) 104 shown—and is available to charge a battery when, for example, an adapter is connected at an input port 101. For example, charger 102 provides buck charging functionality, boost charging functionality, and/or the like. In one embodiment, IC 104 is an IC die (e.g., a system-on-chip, or “SoC”) or other integrated circuitry such as that of a mobile computing system including, but not limited to, a smartphone, tablet, or laptop computer, for example. In other embodiments, IC 104 is that of a desktop, server or other suitable device. Such an IC 104 often has a processor, a memory, one or more communication devices, and other components that are powered by one or more rechargeable cells of a battery pack 103, and potentially by power from an external power source (e.g., an adapter, etc.) (not shown). In one embodiment, battery pack 103 provides power to IC 104 when an external power source is not available. In one embodiment, battery pack 103 is a lithium-ion battery pack. In the illustrative embodiment shown, battery pack 103 is coupled via a connector 107—e.g., wherein battery pack 103 is a pluggable device. Note that the embodiments described herein are not limited to use of a lithium-ion battery pack and other rechargeable batteries may be used.

In one embodiment, the power delivery system includes energy storage 106 which supplements the voltage provided by battery pack 103 to IC 104 in certain situations. In one embodiment, energy storage 106 comprises a component(s) for input decoupling of the charger in the form of one or more capacitors (e.g., a ceramic capacitor, an electrolytic capacitor, etc.) coupled together (e.g., in series). In one embodiment, the capacitor of energy storage 106 is implemented by one or more individual capacitors coupled together in parallel or series.

In various embodiments, charger 102 is coupled to provide a first voltage—e.g., via the illustrative switch circuit 110b shown—to a voltage regulator (VR) 120, which in turn provides to IC 104 a second voltage which is based on said first voltage. At various times, battery pack 103 is instead to provide the first voltage to VR 120. In one embodiment, VR 120 includes (or alternatively, is coupled to operate with) circuitry which monitors the voltage and/or power provided to IC 104 to determine if the voltage droops below a predetermined level (or the power goes above the battery capability). In one embodiment, such circuitry monitors the voltage being supplied by battery pack 103 to IC 104, wherein the energy storage 106 (e.g., a capacitor) coupled to VR 120 supplements the supply of power to IC 104 when the voltage supplied to IC 104 by battery pack 103, as monitored by VR 120, drops below a first threshold voltage level, which is above a minimum voltage level associated with IC 104. In another embodiment, the voltage monitoring can be done by controller circuitry (not shown) of charger 102. Note that current or power may be monitored instead of voltage to determine if the voltage provided to IC 104 has dropped or may drop below the predetermined level.

In one embodiment, charger 102 charges battery pack 103 and at times charges energy storage 106 when the AC adapter is not present at the input port. In one embodiment, battery charger 102 also charges energy storage 106 when the voltage being supplied by battery pack 103 to IC 104 is above a second threshold level that is higher than another (first) threshold level that is used to trigger the usage of energy storage 106 to supplement power to IC 104. In such a case, battery charger 102 does not charge energy storage 106 when the voltage being supplied by battery pack 103 to IC 104 is below the second threshold level but higher than the first threshold level. In one embodiment, voltage monitoring circuitry (of VR 120, for example) monitors the voltage being supplied by battery pack 103 to IC 104 to determine when battery charger 102 charges energy storage 106.

In one embodiment, charger 102 maintains the necessary amount of energy in energy storage 106, unless the SoC goes into a low power mode, and there is no possibility of the system load to spike to the level sufficient to droop the system voltage below the minimum system requirements. Switch 115 is used to decouple input port 101 from battery charger 102 and energy storage 106 when no device is connected to the Input Port 101. In one embodiment, energy storage 106 is discharged to battery pack 103 when a power adaptor is coupled to input port 101. In one embodiment, energy storage 106 is discharged in response to the power adaptor being connected to input port 101 but prior to the adaptor providing power to IC 104 through input port 101.

In one embodiment, controller circuitry 105 is coupled to and controls various other components of system 100 to determine (for example) when energy storage 106 is to supplement the power provided by battery pack 103 to IC 104, charge and discharge energy storage 106, as well as couple and decouple components at specific times.

In one embodiment, system 100 further comprises switch circuitry—e.g., including some or all of the illustrative switch circuits 110a, 110b, 110c, 110d shown—which is to variously provide or prevent one or more conductive paths each between a respective two power delivery resources. By way of illustration and not limitation, switch circuit 110a is coupled to selectively enable (or disable) a conductive path between charger 102 and each of energy storage 106 and input port 101—e.g., wherein switch circuit 110b is coupled to similarly provide or prevent a conductive path between charger 102 and VR 120. Alternatively or in addition, switch circuit 110c is coupled to provide or prevent a conductive path between one or more battery cells (not shown) of battery pack 103 and an output terminal by which battery pack 103 is coupled to connector 107—e.g., wherein switch circuit 110d is coupled to similarly provide or prevent a conductive path between connector 107 and each of charger 102 and VR 120. In various embodiments, system 100 includes one or more additional or alternative switch circuits which selectively facilitate electrical coupling or decoupling between various power delivery resources. Some or all such switch circuits include any of various discrete field effect transistors (FETs) (such as metal oxide FETS, or “MOSFETs”), load switches or other suitable switch devices.

In one illustrative embodiment, switch circuit 110a is used when an external power source (e.g., a power adaptor) is coupled to provide power to IC 104. In one embodiment, an external power source may be coupled to IC 104 via input port 101. In one embodiment, the power source comprises a power source of undetermined output power. In one embodiment where input port 101 is a Type C USB connector, the power source is a Universal Serial Bus (USB) Power Delivery (PD) power supply. In one embodiment, the power source is a wireless power source. In another embodiment, the power source is a solar power source. In some embodiments, the energy storage 106 or a portion of it can be disconnected from other hardware of system 100 with a switch in order to minimize its leakage or in order to avoid the necessity to fully discharge it when a device is connected at the input port 101 and the switch 115 is turned on.

In various use cases, system 100—e.g., a mobile platform (for example)—is generally not in use for a significant amount of time in a given day. During such times, system 100 is operable to transition to an aggressively low power state wherein power delivery to IC 104 by VR 120 is disabled. For example, one such low power state is the pseudo-G3 (PG3) power state which is supported by various devices from Intel Corporation of Santa Clara, CA. During a PG3 power state, all power delivery to a given IC die is turned off—e.g., with the exception of power which enables the provisioning of a real time clock (RTC) signal to that IC die.

In existing platforms, some amount of power is nevertheless consumed by various power delivery resources during such a low power state. One such power delivery resource is a voltage regulator, which remains in a quiescent power state that can nevertheless result in power consumption that, for example, is on the order of 60 milliwatts (mW). Another example resource is power state controller circuitry which arranges the transitioning of system hardware to the low power state and/or from the low power state. Still another example resource is an embedded controller which is coupled between (and facilitates communication between) the IC die and the power state controller circuitry. Yet another example resource is other controller circuitry which, for example, operates the switch circuitry of a battery charger.

Some embodiments variously mitigate such power consumption by facilitating the operation of switch circuitry to electrically decouple a battery charger and/or a battery pack from a voltage regulator during a low power state (such as a PG3 state). In an illustrative scenario according to one such embodiment, IC 104 provides a communication which directly or indirectly indicates to controller circuitry 105 that IC 104 is currently able to accommodate a transition of system 100 to a power state wherein power delivery from VR 120 to IC 104 is disabled. In one such embodiment, the power state further comprises a clock circuit (not shown) remaining powered up to make a real time clock (RTC) signal available to IC 104—e.g., while any other rail to IC 104 is powered down. In some embodiments, the power state further comprises some or all of controller circuitry 105 remaining powered up so that system 100 can be woken from said low power state.

In various embodiments, controller circuitry 105 generates one or more switch control signals, responsive to the indication from IC 104, to disable one or more conductive paths each between a respective two resources including charger 102, VR 120, connector 107, and battery pack 103). By way of illustration and not limitation, during the low power state, switch circuit 110c of battery pack 103 is configured to electrically decouple one or more cells of battery pack 103 from an output terminal of battery pack 103 (e.g., wherein the output terminal is otherwise to facilitate the provisioning of a voltage between the one or more cells and one of the charger 102 or VR 120). Additionally or alternatively, during the low power state, switch circuit 110b is configured to an “open circuit” state which electrically decouples an output terminal of charger 102 from an input terminal of VR 120. Additionally or alternatively, during the low power state, switch circuit 110d is configured to an open circuit state which electrically decouples a contact of connector 107 (and thus, an output terminal of battery pack 103) from the input terminal of VR 120 and/or from the output terminal of charger 102. Additionally or alternatively, during the low power state, other switch circuitry (not shown) is configured to an open circuit state which prevents an alternative path between the contact of connector 107 and an input terminal of charger 102. In one such embodiment, electrically decoupling VR 120 from one or both of charger 102 and battery pack 103—and/or electrically decoupling charger 102 from battery pack 103—mitigates power consumption which, for example, would otherwise result from a quiescent operational condition of VR 120 during a PG3 state (or other such low power state) of system 100.

In various embodiments, system 100 omits (but accommodates coupling to) some or all of charger 102, VR 120, IC 104, battery pack 103, energy storage 106, switch 115, and input port 101. In one such embodiment, system 100 includes a printed circuit board (PCB) and circuitry—e.g., including some or all of controller circuitry 105 and some or all of switch circuits 110a, 110b, 110d— which is variously formed in or on the PCB. For example, such a PCB includes, in addition to connector 107, one or more hardware interfaces (not shown) which variously accommodate coupling of system 100 each to a respective one of the charger 102, the VR 120, or the IC 104.

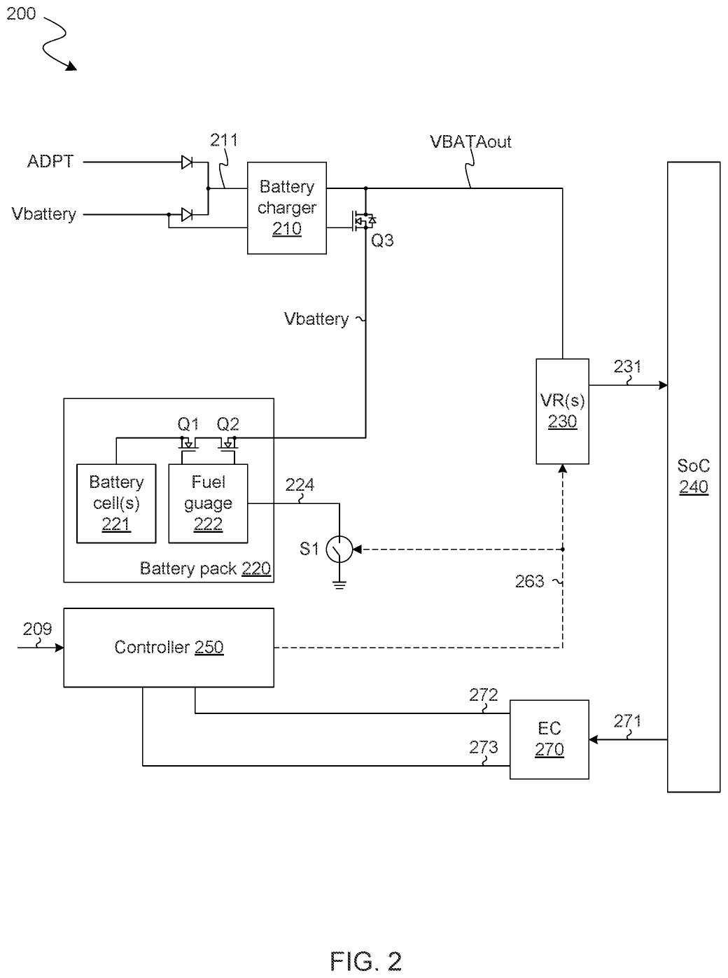

FIG. 2 shows features of a system 200 to decouple a battery charger and/or a voltage regulator from one or more battery cells according to an embodiment. The system 200 illustrates one example of an embodiment wherein, during a lower power state (which disables power delivery by a voltage regulator), switch circuitry is configured to prevent a conductive path between one or more battery cells and a battery charger or the voltage regulator. In various embodiments, system 200 provides functionality such as that of system 100

As shown in FIG. 2, system 200 comprises a battery charger 210, a battery pack 220, a system-on-chip (SoC) 240, and one or more VRs 230 which—for example—correspond functionally to charger 102, battery pack 103, IC 104, and VR 120 (respectively). System 200 further comprises controller circuitry—e.g., including the illustrative embedded controller (EC) 270 and controller 250 shown—which (for example) provides functionality such as that of controller circuitry 105.

In various embodiments, battery pack 220 comprises one or more rechargeable battery cells 221 which are to provide a voltage Vbattery. In one such embodiment, battery pack 220 further comprises a fuel gauge 222 and switch circuitry (including, for example, the illustrative transistors Q1, Q2 shown) which is controlled by fuel gauge 222 to selectively enable or disable a provisioning of voltage Vbattery to one or more other power delivery resources of system 200. For example, fuel gauge 222 comprises circuitry to monitor one or more conditions of battery pack 220 (e.g., including a current level of charge of battery cell(s) 221), wherein—based on the one or more conditions—transistors Q1, Q2 are variously operated to selectively enable or disable a conductive path between battery cell(s) 221 and an output terminal by which battery pack 220 is to provide voltage Vbattery to VR(s) 230 and/or battery charger 210.

For example, one input terminal of battery charger 210 is coupled to receive a voltage 211 which is equal to or otherwise based on either one of the voltage Vbattery, or another voltage ADPT provided by a power adapter (if any) which is coupled to system 200. In one such embodiment, another input terminal of battery charger 210 is coupled to receive the voltage Vbattery directly—e.g., wherein the voltage Vbattery is to power switch control circuitry (not shown) of battery charger 210.

Based on the voltage 211 and the voltage Vbattery, battery charger 210 generates a voltage VBATAout which (for example) is to be output to VR(s) 230 and/or to battery pack 220. In the example embodiment shown, VR(s) 230 is coupled to output a voltage 231 for delivering power to SoC 240—e.g., wherein voltage 231 is based on the voltage VBATAout from battery charger 210. In one such embodiment, system 200 further comprises additional switch circuitry—e.g., including the illustrative transistor Q3 shown—which is coupled to the output terminal of battery charger 210 which provides voltage VBATAout. Such additional switch circuitry is operable in some embodiments to selectively control at least in part whether voltage VBATAout is to charge the battery cell(s) 221.

In an illustrative scenario according to one embodiment, a determination is made—e.g., by control circuitry (not shown) of SoC 240— that system 200 is to transition to a low power state which disables a delivery of power to SoC 240 by VR(s) 230. Based on such a determination, SoC 240 outputs a SUS PWRDNW ACK signal 271 which specifies or otherwise indicates that SoC 240 is ready for a transition by system 200 to the low power state (such as a PG3 state). Based on signal 271, control circuitry of system 200 generates one or more signals to configure the low power state—e.g., wherein one or more power delivery resources are to be electrically decoupled to improve power savings during said low power state.

By way of illustration and not limitation, EC 270 comprises circuitry which is coupled to generate, based on signal 271, another signal 272 which confirms that system 200 is to be transitioned to the low power state. In some embodiments, EC 270 further provides functionality to provide a RTC WAKE EVENT signal 273 which subsequently confirms that system 200 is to be transitioned from the low power state. Signal 272 (and, for example, signal 273) is provided to a controller 250 of system 200.

Based on signal 272, controller 250 generates a signal 263 to disable a delivery of power by VR(s) 230 to SoC 240, where such disabling is to implement at least in part the transition of system 200 to the low power state. Although some embodiments are not limited in this regard, signal 263 is additionally or alternatively asserted or unasserted by controller 250 based on a PWRBTN SW signal 209 which indicates (for example) whether a user of system 200 has pressed a power button switch.

In one example embodiment, switch circuitry of system 200 (e.g., including the illustrative switch S1 shown) is coupled to the controller 250 and to the fuel gauge 222 of battery pack 220. Based on the signal 263, the switch circuit S1 is operable to selectively enable or disable a conductive path by which fuel gauge 222 is to receive a SYS PRESENT signal 224. By way of illustration and not limitation, signal 224 indicates to fuel gauge 222 (and/or other suitable logic of battery pack 220) whether battery pack 220 has been plugged or otherwise coupled to other circuitry of system 200.

In one such embodiment, signal 224 indicates to fuel gauge 222 whether transistors Q1, Q2 (or other suitable switch circuitry of battery pack 220) is to be configured to disable or otherwise prevent a conductive path by which the voltage Vbattery is provided from battery pack 220. For example, based on an indication by signal 263 that the low power state is to be configured, fuel gauge 222 disables transistors Q1, Q2 to prevent a provisioning of the voltage Vbattery to one or more input terminals of battery charger 210 and/or to an input terminal of VR(s) 230. As a result, power consumption by battery charger 210 and/or VR(s) 230 is further reduced during the low power state.

In an illustrative scenario according to one embodiment, signal 263 is an active low signal (i.e., wherein a low voltage of signal 263 indicates that the low power state is to be configured), and battery pack 220 includes an internal pull-up (not shown) for signal 224. In one such embodiment, a logic low value of signal 263 turns off switch S1, which enables signal 224 to be pulled high, which (in turn) results in one or each of transistors Q1, Q2 being in a respective open circuit state.

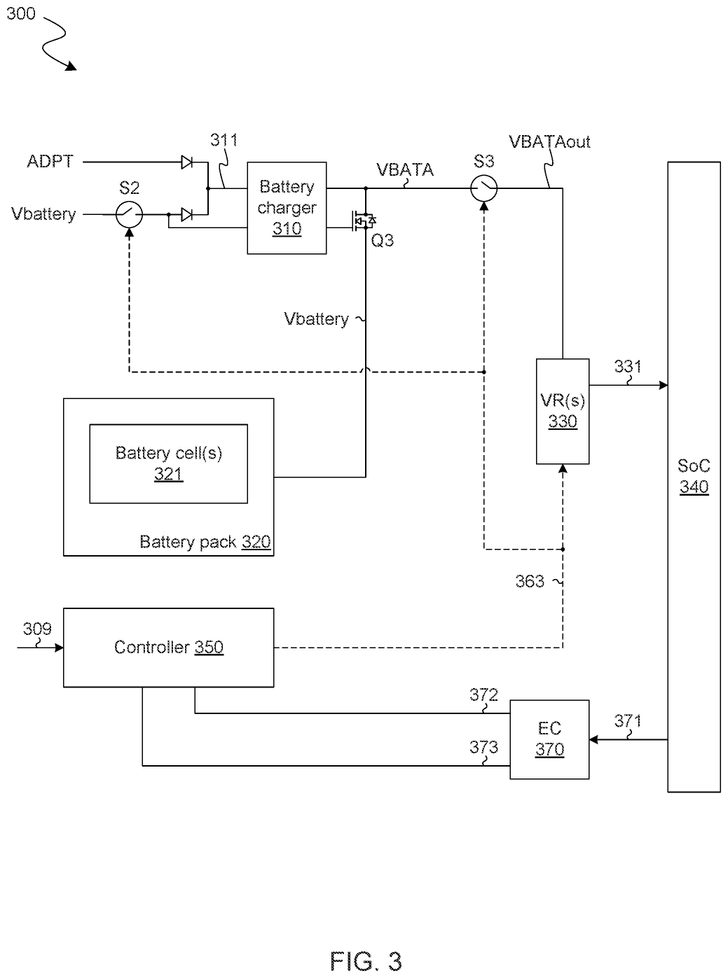

FIG. 3 shows features of a system 300 to decouple a battery charger from a voltage source or a voltage regulator according to an embodiment. The system 300 illustrates one example of an embodiment wherein, during a lower power state (which disables power delivery by a voltage regulator), switch circuitry is configured to prevent a conductive path to an input terminal of a battery charger, and/or to prevent another conductive path which is coupled to an output terminal of a battery charger. In one such embodiment, the input terminal is to receive a voltage from a battery pack—e.g., wherein the output terminal is to provide another voltage, directly or indirectly, to the voltage regulator. In various embodiments, system 300 provides functionality such as that of system 100 or system 200.

As shown in FIG. 3, system 300 comprises a battery charger 310, a battery pack 320, a SoC 340, and one or more VRs 330 which, for example, correspond functionally to battery charger 210, battery pack 220, SoC 240, and VR(s) 230 (respectively). Furthermore, a controller 350 and an embedded controller (EC) 370 of system 300 provide functionality such as that of controller 250 and EC 270 (respectively). In one such embodiment, system 300 variously communicates signals 309, 363, 371, 372, 373 which provide functionality such as that of signals 209, 263, 271, 272, 273 (respectively). For example, such signal communication variously facilitates the provisioning of voltages 311, 331 (such as the respective voltages 211, 231, for example)—e.g., wherein voltages ADPT, Vbattery, and VBATAout correspond to those similarly provided with system 200.

In an illustrative scenario according to one embodiment, SoC 340 outputs a signal 371 which specifies or otherwise indicates that SoC 340 is ready for a transition by system 300 to a PG3 state (or another suitable power state which disables a delivery of power by VR(s) 330 to SoC 340). Based on signal 371, EC 370 generates another signal 372 which confirms that system 300 is to be transitioned to the low power state. Based on signal 372, controller 350 generates a signal 363 to disable a delivery of power by VR(s) 330 to SoC 340, where such disabling is to implement at least in part the transition of system 300 to the low power state.

In one example embodiment, first switch circuitry of system 300 (e.g., including the illustrative switch S2 shown) is coupled to controller 350, to battery pack 320, and to battery charger 310. Based on the signal 363, the switch circuit S2 is operable to selectively enable or disable a conductive path by which the voltage Vbattery is provided from battery pack 320 to one or more input terminals of battery charger 310. For example, based on an indication by signal 363 that the low power state is to be configured, switch S2 is configured in an open circuit state to prevent a provisioning of the voltage Vbattery to the one or more input terminals of battery charger 310.

Additionally or alternatively, second switch circuitry of system 300 (e.g., including the illustrative switch S3 shown) is coupled between an output terminal of battery charger 310 and an input terminal of VR(s) 330. Based on the signal 363, the switch circuit S3 is operable to selectively enable or disable a conductive path by which a voltage VBATA from battery charger 310 is provided (as voltage VBATAout) to VR(s) 330. For example, based on an indication by signal 363 that the low power state is to be configured, switch S3 is configured in an open circuit state to prevent a provisioning of the voltage VBATAout. As a result of switch circuit S2 and/or switch circuit S3 being operated based on signal 363, power consumption by battery charger 310 and/or VR(s) 330 is further reduced during the low power state.

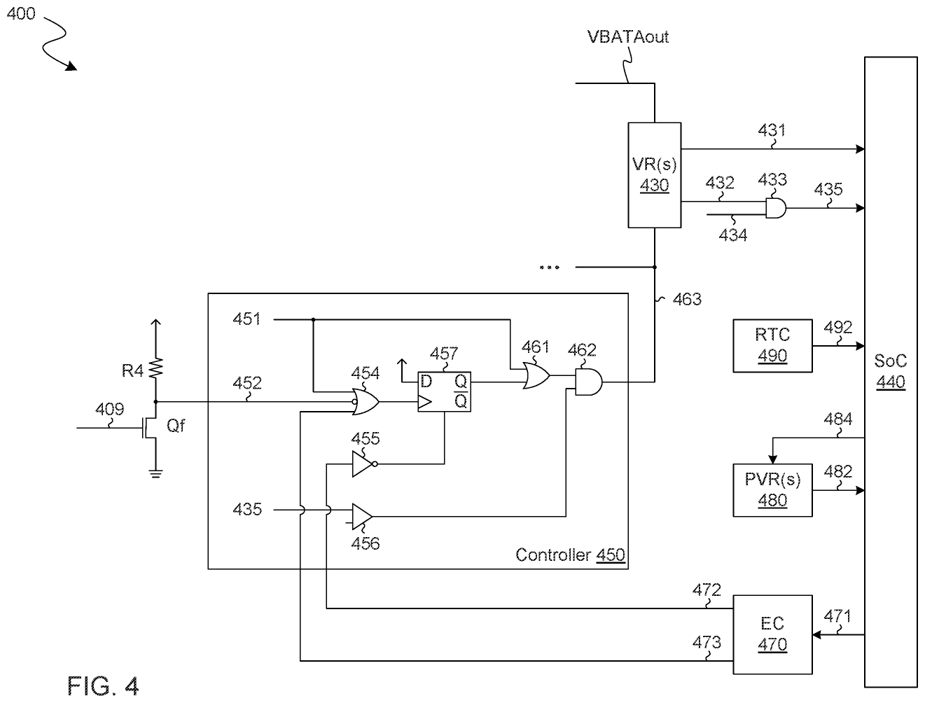

FIG. 4 shows features of a system 400 to generate a switch control signal for electrically decoupling power delivery resources according to an embodiment. The system 400 illustrates one example of an embodiment which is operable to generate one or more control signals for implementing a low power state, wherein various power delivery resources are electrically decoupled from each other based on the one or more control signals. In various embodiments, system 400 provides functionality of one of systems 100, 200, 300.

As shown in FIG. 4, system 400 comprises a SoC 440, and one or more VRs 430 which (for example) correspond functionally to SoC 240, and VR(s) 230 (respectively). System 400 further comprises a controller 450 and an embedded controller (EC) 470 which, for example, correspond functionally to controller 250 and EC 270 (respectively). In one such embodiment, system 400 variously communicates signals 409, 463, 471, 472, 473 which provide functionality such as that of signals 209, 263, 271, 272, 273 (respectively). For example, such signal communication variously facilitates the provisioning of a voltage 431 (such as one of voltages 231, 331, for example)—e.g., wherein a voltage VBATAout provided to VR(s) 430 corresponds to that similarly provided to VR(s) 230 or to VR(s) 330.

In an illustrative scenario according to one embodiment, VR(s) 430 receives a voltage VBATAout (e.g., from a battery charger) and provides to SoC 440 a voltage 431 which is based on the voltage VBATAout. In one such embodiment, VR(s) 430 outputs a DSW PWRGD signal 432 which indicates that the voltage 431 is stable. SoC 440 is coupled to receive a DPWROK signal 435 which is based on signal 432—e.g., wherein signal 435 specifies whether some predetermined one or more criteria for power delivery to SoC 440 are currently being met. For example, an AND gate 433 (or other suitable logic of system 400) generates signal 435 based on both signal 432 and a VBAT MON signal 434 which indicates that voltage VBATAout is being monitored—e.g., by a battery charger (not shown) or other suitable circuitry of system 400.

At some point during operations based on voltage VBATAout, SoC 440 determines that system 400 is to be transitioned to a power state (such as a PG3 state) wherein power delivery from VR(s) 430 to SoC 440 is disabled. In one such embodiment, the power state enables a clock circuit RTC 490 to provide to SoC 440 a real time clock signal 492. However, in various embodiments, the power state disables any other rails—e.g., including the illustrative one or more rails 482 from one or more platform voltage regulators PVR(s) 480— which are to deliver power to SoC 440 and/or other platform components. Although some embodiments are not limited in this regard, the disabling of the one or more rails 482 is performed, for example, in response to a PM_SLP_SUS_IN signal 484 from SoC 440.

Where it is determined that system 400 is to transition to the low power state, SoC 440 provides the signal 471 to EC 470, which in turn generates signal 472 to indicate to controller 450 that the power state transition is to be performed. Based on signal 472, controller 450 generates the signal 463 to disable a delivery of power by VR(s) 430 to SoC 440, where such disabling is to implement at least in part the transition of system 400 to the low power state. By way of illustration and not limitation, controller 450 comprises logic gates 454, 455, 456, 461, 462, and a flip-flop 457, which are configured to selectively assert (or deassert) signal 463 based on signals 409, 472, and 473. For example, controller 450 receives a PWRBTN signal 452 which indicates an occurrence of a power button press event—e.g., wherein signal 452 is generated with a resistor R4 and a transistor Qf (or other suitable circuitry such as a power switch) based on signal 409. In one such embodiment, controller 450 generates signal 463 further based on a BC ACOK signal 451 which indicates whether a power adapter is currently connected to system 400 (e.g., via a port such as input port 101). Alternatively or in addition, controller 450 generates signal 463 further based on the signal 435 which is generated with AND gate 433.

In some embodiments, signal 463 is further provided to switch circuitry (not shown) which is to electrically decouple various power delivery resources from each other at least partially. In one such embodiment, such switch circuitry provides functionality such as that of switch S1 in system 200, that of switch S2 in system 300, and/or that of switch S3 in system 300. In providing signal 463 to operate such switch circuitry, some embodiments improve the power efficiency of a low power state (such as a PG3 state) of system 400.

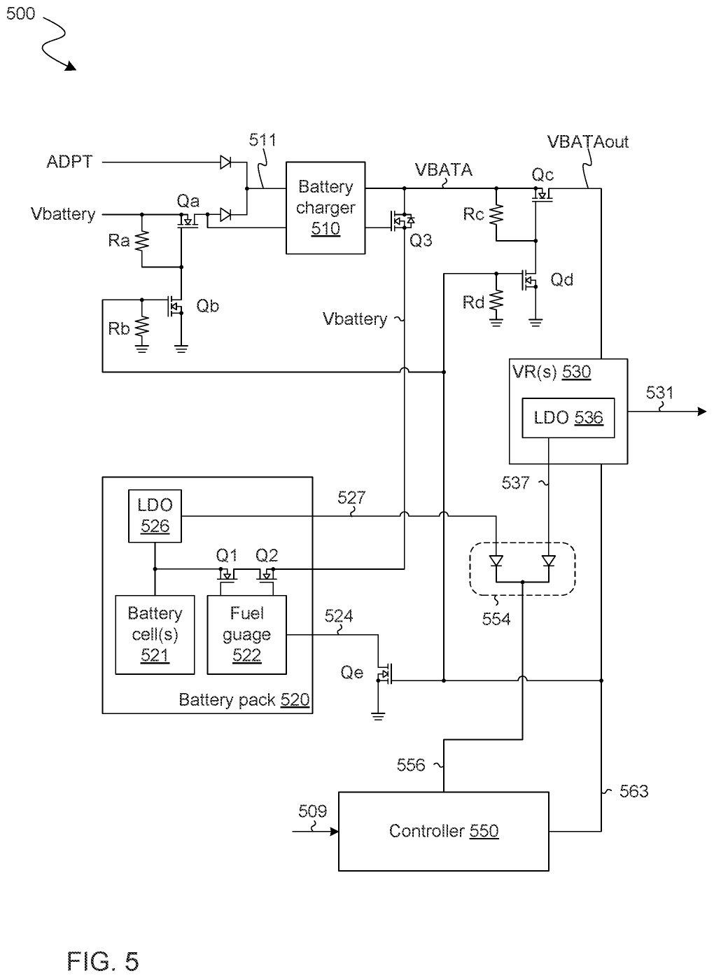

FIG. 5 shows features of a system 500 to provide for electrically decoupling of a battery charger from a battery cell and/or a voltage regulator during a low power state according to an embodiment. The system 500 illustrates one example of an embodiment wherein—during a power state which disables power delivery by a voltage regulator—switch circuitry is configured to prevent conductive paths each between a respective two of a battery charger, a battery pack, or a voltage regulator. In various embodiments, system 500 provides functionality such as that one of systems 100, 200, 300, 400.

As shown in FIG. 5, system 500 comprises a battery charger 510, a battery pack 520, and one or more VRs 530 which, for example, correspond functionally to battery charger 210, battery pack 220, and VR(s) 230 (respectively). Furthermore, a controller 550 of system 500 provides functionality such as that of controller 250 (and of EC 270, for example). In one such embodiment, system 500 variously communicates signals 509, 524, 563 which provide functionality such as that of signals 209, 224, 263 (respectively). For example, such signal communication variously facilitates the provisioning of voltages 511, 531 (such as the respective voltages 211, 231, for example)—e.g., wherein voltages ADPT, Vbattery, VBATA and VBATAout correspond to those similarly provided with one of systems 200, 300, 400.

In the example embodiment shown, battery pack 520 comprises one or more battery cells 521 and a fuel gauge 522 which provide functionality (such as that of battery cell(s) 221 and fuel gauge 222, respectively) to selectively output voltage Vbattery based at least in part on signal 524. In one such embodiment, a transistor Qe (corresponding functionally to switch S1 of system 200) facilitates communication of signal 524 to fuel gauge 522 based on signal 563—e.g., wherein transistors Q1, Q2 of battery pack 520 are variously operated by battery pack 520 in response to signal 524.

Alternatively or in addition, system 500 comprises a first arrangement of resistors Ra, Rb and transistors Qa, Qb between an output terminal of battery pack 520 (i.e., the output terminal by which voltage Vbattery is provided), and one or more input terminals of battery charger 510. In one such embodiment, this first arrangement provides functionality (such as that of switch S2 of system 300) to disable a conductive path between battery pack 520 and battery charger 510 during a low power state, wherein such disabling is responsive to signal 563.

Alternatively or in addition, system 500 comprises a second arrangement of resistors Rc, Rd and transistors Qc, Qd between an output terminal of battery charger 510 (i.e., the output terminal by which voltage VBATA is provided), and an input terminal of VR(s) 530. In one such embodiment, this second arrangement provides functionality (such as that of switch S3 of system 300) to disable a conductive path between VR(s) 530 and each of battery pack 520 and battery charger 510 during a low power state, wherein such disabling is responsive to signal 563.

In various embodiments, system 500 further comprises circuitry 554 which is coupled to receive the voltage Vbattery via a path 527 of the battery charger 510 which is independent of the transistors Q1, Q2 which are otherwise used to selectively provide voltage Vbattery to battery charger 510 and/or VR(s) 530. The circuitry 554 is further coupled to receive, from the VR(s) 530, a voltage 537 which is equal to or otherwise based on the voltage VBATAout. In an illustrative scenario according to one embodiment, path 527 is between circuitry 554 and a low dropout regulator circuit LDO 526 of the battery pack 520—e.g., wherein circuitry 554 receives the voltage 537 from another low dropout regulator circuit LDO 536 of the VR(s) 530.

In one such embodiment, circuitry 554 is coupled to deliver power to the controller 550 with either of voltage Vbattery or the voltage 537. As a result, controller 550 remains powered and available to recover system 500 from the low power state—e.g., wherein said recovery is based on a signal (not shown) such as the signal 273 which is provided to controller 250.

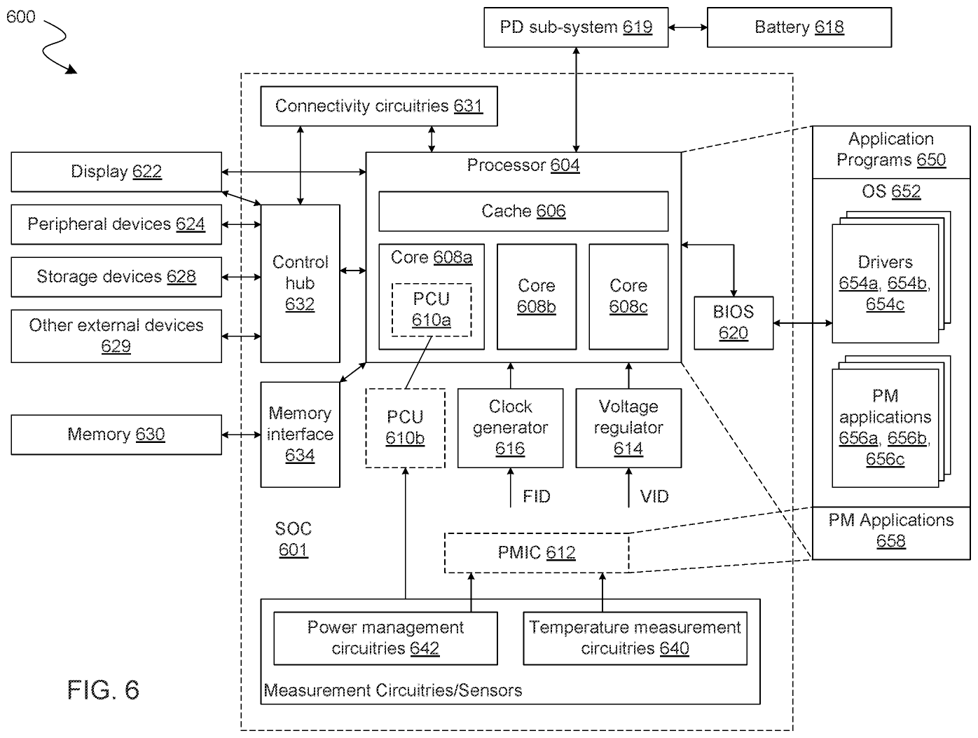

FIG. 6 illustrates a computer system or computer device 600 (also referred to as device 600), where power delivery resources are to be electrically decoupled from each other during a low power state, in accordance with some embodiments. It is pointed out that those elements of FIG. 6 having the same reference numbers (or names) as the elements of any other figure can operate or function in any manner similar to that described, but are not limited to such.

In some embodiments, device 600 represents an appropriate computer device, such as a computer tablet, a mobile phone or smart-phone, a laptop, a desktop, an Internet-of-Things (JOT) device, a server, a wearable device, a set-top box, a wireless-enabled e-reader, or the like. It will be understood that certain components are shown generally, and not all components of such a device are shown in device 600.

In an example, the device 600 comprises a SoC (System-on-Chip) 601. An example boundary of the SOC 601 is illustrated using dotted lines in FIG. 6, with some example components being illustrated to be included within SOC 601— however, SOC 601 may include any appropriate components of device 600.

In some embodiments, device 600 includes processor 604. Processor 604 can include one or more physical devices, such as microprocessors, application processors, microcontrollers, programmable logic devices, processing cores, or other processing means. The processing operations performed by processor 604 include the execution of an operating platform or operating system on which applications and/or device functions are executed. The processing operations include operations related to I/O (input/output) with a human user or with other devices, operations related to power management, operations related to connecting computer device 600 to another device, and/or the like. The processing operations may also include operations related to audio I/O and/or display I/O.

In some embodiments, processor 604 includes multiple processing cores (also referred to as cores) 608a, 608b, 608c. Although merely three cores 608a, 608b, 608c are illustrated in FIG. 6, the processor 604 may include any other appropriate number of processing cores, e.g., tens, or even hundreds of processing cores. Processor cores 608a, 608b, 608c may be implemented on a single integrated circuit (IC) chip. Moreover, the chip may include one or more shared and/or private caches, buses or interconnections, graphics and/or memory controllers, or other components.

In some embodiments, processor 604 includes cache 606. In an example, sections of cache 606 may be dedicated to individual cores 608 (e.g., a first section of cache 606 dedicated to core 608a, a second section of cache 606 dedicated to core 608b, and so on). In an example, one or more sections of cache 606 may be shared among two or more of cores 608. Cache 606 may be split in different levels, e.g., level 1 (L1) cache, level 2 (L2) cache, level 3 (L3) cache, etc.

In some embodiments, a given processor core (e.g., core 608a) may include a fetch unit to fetch instructions (including instructions with conditional branches) for execution by the core 608a. The instructions may be fetched from any storage devices such as the memory 630. Processor core 608a may also include a decode unit to decode the fetched instruction. For example, the decode unit may decode the fetched instruction into a plurality of micro-operations. Processor core 608a may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, an execution unit may execute instructions out-of-order. Hence, processor core 608a (for example) may be an out-of-order processor core in one embodiment. Processor core 608a may also include a retirement unit. The retirement unit may retire executed instructions after they are committed. In an embodiment, retirement of the executed instructions may result in processor state being committed from the execution of the instructions, physical registers used by the instructions being de-allocated, etc. The processor core 608a may also include a bus unit to enable communication between components of the processor core 608a and other components via one or more buses. Processor core 608a may also include one or more registers to store data accessed by various components of the core 608a (such as values related to assigned apparatus priorities and/or sub-system states (modes) association.

In some embodiments, device 600 comprises connectivity circuitries 631. For example, connectivity circuitries 631 includes hardware devices (e.g., wireless and/or wired connectors and communication hardware) and/or software components (e.g., drivers, protocol stacks), e.g., to enable device 600 to communicate with external devices. Device 600 may be separate from the external devices, such as other computer devices, wireless access points or base stations, etc.

In an example, connectivity circuitries 631 may include multiple different types of connectivity. To generalize, the connectivity circuitries 631 may include cellular connectivity circuitries, wireless connectivity circuitries, etc. Cellular connectivity circuitries of connectivity circuitries 631 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 631 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 631 may include a network interface, such as a wired or wireless interface, e.g., so that a system embodiment may be incorporated into a wireless device, for example, cell phone or personal digital assistant.

In some embodiments, device 600 comprises control hub 632, which represents hardware devices and/or software components related to interaction with one or more I/O devices. For example, processor 604 may communicate with one or more of display 622, one or more peripheral devices 624, storage devices 628, one or more other external devices 629, etc., via control hub 632. Control hub 632 may be a chipset, a Platform Control Hub (PCH), and/or the like.

For example, control hub 632 illustrates one or more connection points for additional devices that connect to device 600, e.g., through which a user might interact with the system. For example, devices (e.g., devices 629) that can be attached to device 600 include microphone devices, speaker or stereo systems, audio devices, video systems or other display devices, keyboard or keypad devices, or other I/O devices for use with specific applications such as card readers or other devices.

As mentioned above, control hub 632 can interact with audio devices, display 622, etc. For example, input through a microphone or other audio device can provide input or commands for one or more applications or functions of device 600. Additionally, audio output can be provided instead of, or in addition to display output. In another example, if display 622 includes a touch screen, display 622 also acts as an input device, which can be at least partially managed by control hub 632. There can also be additional buttons or switches on computer device 600 to provide I/O functions managed by control hub 632. In one embodiment, control hub 632 manages devices such as accelerometers, cameras, light sensors or other environmental sensors, or other hardware that can be included in device 600. The input can be part of direct user interaction, as well as providing environmental input to the system to influence its operations (such as filtering for noise, adjusting displays for brightness detection, applying a flash for a camera, or other features).

In some embodiments, control hub 632 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 622 represents hardware (e.g., display devices) and software (e.g., drivers) components that provide a visual and/or tactile display for a user to interact with device 600. Display 622 may include a display interface, a display screen, and/or hardware device used to provide a display to a user. In some embodiments, display 622 includes a touch screen (or touch pad) device that provides both output and input to a user. In an example, display 622 may communicate directly with the processor 604. Display 622 can be one or more of an internal display device, as in a mobile electronic device or a laptop device or an external display device attached via a display interface (e.g., DisplayPort, etc.). In one embodiment display 622 can be a head mounted display (HMD) such as a stereoscopic display device for use in virtual reality (VR) applications or augmented reality (AR) applications.

In some embodiments and although not illustrated in the figure, in addition to (or instead of) processor 604, device 600 may include Graphics Processing Unit (GPU) comprising one or more graphics processing cores, which may control one or more aspects of displaying contents on display 622.

Control hub 632 (or platform controller hub) may include hardware interfaces and connectors, as well as software components (e.g., drivers, protocol stacks) to make peripheral connections, e.g., to peripheral devices 624.

It will be understood that device 600 could both be a peripheral device to other computer devices, as well as have peripheral devices connected to it. Device 600 may have a “docking” connector to connect to other computer devices for purposes such as managing (e.g., downloading and/or uploading, changing, synchronizing) content on device 600. Additionally, a docking connector can allow device 600 to connect to certain peripherals that allow computer device 600 to control content output, for example, to audiovisual or other systems.

In addition to a proprietary docking connector or other proprietary connection hardware, device 600 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 631 may be coupled to control hub 632, e.g., in addition to, or instead of, being coupled directly to the processor 604. In some embodiments, display 622 may be coupled to control hub 632, e.g., in addition to, or instead of, being coupled directly to processor 604.

In some embodiments, device 600 comprises memory 630 coupled to processor 604 via memory interface 634. Memory 630 includes memory devices for storing information in device 600. Memory can include nonvolatile (state does not change if power to the memory device is interrupted) and/or volatile (state is indeterminate if power to the memory device is interrupted) memory devices. Memory device 630 can be a dynamic random access memory (DRAM) device, a static random access memory (SRAM) device, flash memory device, phase-change memory device, or some other memory device having suitable performance to serve as process memory. In one embodiment, memory 630 can operate as system memory for device 600, to store data and instructions for use when the one or more processors 604 executes an application or process. Memory 630 can store application data, user data, music, photos, documents, or other data, as well as system data (whether long-term or temporary) related to the execution of the applications and functions of device 600.

Elements of various embodiments and examples are also provided as a machine-readable medium (e.g., memory 630) for storing the computer-executable instructions (e.g., instructions to implement any other processes discussed herein). The machine-readable medium (e.g., memory 630) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 600 comprises temperature measurement circuitries 640, e.g., for measuring temperature of various components of device 600. In an example, temperature measurement circuitries 640 may be embedded, or coupled or attached to various components, whose temperature are to be measured and monitored. For example, temperature measurement circuitries 640 may measure temperature of (or within) one or more of cores 608a, 608b, 608c, voltage regulator 614, memory 630, a mother-board of SOC 601, and/or any appropriate component of device 600.

In some embodiments, device 600 comprises power measurement circuitries 642, e.g., for measuring power consumed by one or more components of the device 600. In an example, in addition to, or instead of, measuring power, the power measurement circuitries 642 may measure voltage and/or current. In an example, the power measurement circuitries 642 may be embedded, or coupled or attached to various components, whose power, voltage, and/or current consumption are to be measured and monitored. For example, power measurement circuitries 642 may measure power, current and/or voltage supplied by one or more voltage regulators 614, power supplied to SOC 601, power supplied to device 600, power consumed by processor 604 (or any other component) of device 600, etc.

In some embodiments, device 600 comprises one or more voltage regulator circuitries, generally referred to as voltage regulator (VR) 614. VR 614 generates signals at appropriate voltage levels, which may be supplied to operate any appropriate components of the device 600. Merely as an example, VR 614 is illustrated to be supplying signals to processor 604 of device 600. In some embodiments, VR 614 receives one or more Voltage Identification (VID) signals, and generates the voltage signal at an appropriate level, based on the VID signals. Various type of VRs may be utilized for the VR 614. For example, VR 614 may include a “buck” VR, “boost” VR, a combination of buck and boost VRs, low dropout (LDO) regulators, switching DC-DC regulators, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR which is controlled by PCU 610a/b and/or PMIC 612. In some embodiments, each core has a network of distributed LDOs to provide efficient control for power management. The LDOs can be digital, analog, or a combination of digital or analog LDOs.

In some embodiments, device 600 comprises one or more clock generator circuitries, generally referred to as clock generator 616. Clock generator 616 generates clock signals at appropriate frequency levels, which may be supplied to any appropriate components of device 600. Merely as an example, clock generator 616 is illustrated to be supplying clock signals to processor 604 of device 600. In some embodiments, clock generator 616 receives one or more Frequency Identification (FID) signals, and generates the clock signals at an appropriate frequency, based on the FID signals.

In some embodiments, device 600 comprises battery 618 supplying power to various components of device 600—e.g., via the illustrative power delivery (PD) sub-system 619 shown. Merely as an example, battery 618 is illustrated to be supplying power to processor 604. Although not illustrated in the figures, PD sub-system 619 may comprise a charging circuitry, e.g., to recharge the battery, based on Alternating Current (AC) power supply received from an AC adapter.

In some embodiments, device 600 comprises Power Control Unit (PCU) 610 (also referred to as Power Management Unit (PMU), Power Controller, etc.). In an example, some sections of PCU 610 may be implemented by one or more processing cores 608, and these sections of PCU 610 are symbolically illustrated using a dotted box and labelled PCU 610a. In an example, some other sections of PCU 610 may be implemented outside the processing cores 608, and these sections of PCU 610 are symbolically illustrated using a dotted box and labelled as PCU 610b. PCU 610 may implement various power management operations for device 600. PCU 610 may include hardware interfaces, hardware circuitries, connectors, registers, etc., as well as software components (e.g., drivers, protocol stacks), to implement various power management operations for device 600.

In some embodiments, device 600 comprises Power Management Integrated Circuit (PMIC) 612, e.g., to implement various power management operations for device 600. In some embodiments, PMIC 612 is a Reconfigurable Power Management ICs (RPMICs) and/or an IMVP (Intel® Mobile Voltage Positioning). In an example, the PMIC is within an IC chip separate from processor 604. The may implement various power management operations for device 600. PMIC 612 may include hardware interfaces, hardware circuitries, connectors, registers, etc., as well as software components (e.g., drivers, protocol stacks), to implement various power management operations for device 600.

In an example, device 600 comprises one or both PCU 610 or PMIC 612. In an example, any one of PCU 610 or PMIC 612 may be absent in device 600, and hence, these components are illustrated using dotted lines.

Various power management operations of device 600 may be performed by PCU 610, by PMIC 612, or by a combination of PCU 610 and PMIC 612. For example, PCU 610 and/or PMIC 612 may select a power state (e.g., P-state) for various components of device 600. For example, PCU 610 and/or PMIC 612 may select a power state (e.g., in accordance with the ACPI (Advanced Configuration and Power Interface) specification) for various components of device 600. Merely as an example, PCU 610 and/or PMIC 612 may cause various components of the device 600 to transition to a sleep state, to an active state, to an appropriate C state (e.g., C0 state, or another appropriate C state, in accordance with the ACPI specification), etc. In an example, PCU 610 and/or PMIC 612 may control a voltage output by VR 614 and/or a frequency of a clock signal output by the clock generator, e.g., by outputting the VID signal and/or the FID signal, respectively. In an example, PCU 610 and/or PMIC 612 may control battery power usage, charging of battery 618, and features related to power saving operation.

The clock generator 616 can comprise a phase locked loop (PLL), frequency locked loop (FLL), or any suitable clock source. In some embodiments, each core of processor 604 has its own clock source. As such, each core can operate at a frequency independent of the frequency of operation of the other core. In some embodiments, PCU 610 and/or PMIC 612 performs adaptive or dynamic frequency scaling or adjustment. For example, clock frequency of a processor core can be increased if the core is not operating at its maximum power consumption threshold or limit. In some embodiments, PCU 610 and/or PMIC 612 determines the operating condition of each core of a processor, and opportunistically adjusts frequency and/or power supply voltage of that core without the core clocking source (e.g., PLL of that core) losing lock when the PCU 610 and/or PMIC 612 determines that the core is operating below a target performance level. For example, if a core is drawing current from a power supply rail less than a total current allocated for that core or processor 604, then PCU 610 and/or PMIC 612 can temporarily increase the power draw for that core or processor 604 (e.g., by increasing clock frequency and/or power supply voltage level) so that the core or processor 604 can perform at a higher performance level. As such, voltage and/or frequency can be increased temporality for processor 604 without violating product reliability.

In an example, PCU 610 and/or PMIC 612 may perform power management operations, e.g., based at least in part on receiving measurements from power measurement circuitries 642, temperature measurement circuitries 640, charge level of battery 618, and/or any other appropriate information that may be used for power management. To that end, PMIC 612 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computer system. Additionally, sensor(s) may be directly coupled to PCU 610 and/or PMIC 612 in at least one embodiment to allow PCU 610 and/or PMIC 612 to manage processor core energy at least in part based on value(s) detected by one or more of the sensors.

Also illustrated is an example software stack of device 600 (although not all elements of the software stack are illustrated). Merely as an example, processors 604 may execute application programs 650, Operating System 652, one or more Power Management (PM) specific application programs (e.g., generically referred to as PM applications 658), and/or the like. PM applications 658 may also be executed by the PCU 610 and/or PMIC 612. OS 652 may also include one or more PM applications 656a, 656b, 656c. The OS 652 may also include various drivers 654a, 654b, 654c, etc., some of which may be specific for power management purposes. In some embodiments, device 600 may further comprise a Basic Input/Output System (BIOS) 620. BIOS 620 may communicate with OS 652 (e.g., via one or more drivers 654), communicate with processors 604, etc.

For example, one or more of PM applications 658, 656, drivers 654, BIOS 620, etc. may be used to implement power management specific tasks, e.g., to control voltage and/or frequency of various components of device 600, to control wake-up state, sleep state, and/or any other appropriate power state of various components of device 600, control battery power usage, charging of the battery 618, features related to power saving operation, etc. In various embodiments, functionality of one of systems 100, 200, 300, 400 or 500 is provided (for example) with some or all of PCU 610a, PCU 610b, PMIC 612, PM applications 658, 656, drivers 654, BIOS 620, PD sub-system 619 or battery 618—e.g., wherein PD sub-system 619 comprises a battery charger, a voltage regulator, controller circuitry, and switch circuitry to facilitate such functionality.

In this description, numerous details are detailed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In one or more first embodiments, a device comprises a controller circuit to be coupled to a battery charger which is to output a first voltage, a voltage regulator which is to output a second voltage based on the first voltage, and an integrated circuit (IC) die which is to receive power from the voltage regulator based on the second voltage, and further to output a first signal which indicates that the IC die is able to accommodate a power state wherein the voltage regulator is disabled, wherein, based on the first signal, the controller circuit to generate a second signal to disable the voltage regulator, a connector to receive a battery pack which is to be charged with the battery charger, first switch circuitry coupled to the controller circuit and to the connector, wherein based on the second signal, the first switch circuitry is to selectively disable a first conductive path while the battery pack is coupled to the connector, the first conductive path to communicate a third signal to the battery pack, wherein based on the third signal, second switch circuitry of the battery pack is to enable an output of a third voltage from the battery pack.

In one or more second embodiments, further to the first embodiment, the device further comprises third switch circuitry coupled between the connector and an input terminal of the battery charger, wherein based on the second signal, the third switch circuitry is to selectively disable a second conductive path while the battery pack is coupled to the connector, wherein the third voltage is to be provided to the input terminal while the second conductive path is enabled.

In one or more third embodiments, further to the second embodiment, the device further comprises fourth switch circuitry coupled between the voltage regulator and an output terminal of the battery charger, wherein based on the second signal, the fourth switch circuitry is to selectively disable a third conductive path, wherein the battery charger is to provide the first voltage to the voltage regulator while the third conductive path is enabled.

In one or more fourth embodiments, further to the first embodiment or the second embodiment, the device further comprises third switch circuitry coupled between the voltage regulator and an output terminal of the battery charger, wherein based on the second signal, the third switch circuitry is to selectively disable a second conductive path, wherein the battery charger is to provide the first voltage to the voltage regulator while the second conductive path is enabled.

In one or more fifth embodiments, further to any of the first, second or fourth embodiments, the device further comprises first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

In one or more sixth embodiments, further to the fifth embodiment, the first circuitry is to delivery power to the controller circuit with one of the third voltage during the power state.

In one or more seventh embodiments, further to the fifth embodiment, the first circuitry is to receive the third voltage from a first low dropout regulator circuit of the battery pack, or the first circuitry is to receive the fourth voltage from a second low dropout regulator circuit of the voltage regulator.

In one or more eighth embodiments, further to any of the first, second or fourth embodiments during the power state, a first power rail is to be enabled, and the IC die is to receive a real time clock signal which is generated based on the first power rail.

In one or more ninth embodiments, further to the eighth embodiment, during the power state, any other power rail which is to deliver power to the IC die is disabled.

In one or more tenth embodiments, a system comprises a battery charger to output a first voltage, a battery pack to receive a charge from the battery charger, a voltage regulator coupled to the battery charger, the voltage regulator to output a second voltage based on the first voltage, an integrated circuit (IC) die coupled to receive power from the voltage regulator based on the second voltage, and further to output a first signal which indicates that the IC die is able to accommodate a power state wherein the voltage regulator is disabled, a controller circuit coupled to the IC die and the voltage regulator, the controller circuit to generate, based on the first signal, a second signal to disable the voltage regulator, and first switch circuitry coupled between an output terminal of the battery pack and an input terminal of the battery charger, wherein based on the second signal, the first switch circuitry is to selectively disable a first conductive path, wherein a third voltage is to be provided from the battery charger to the input terminal while the first conductive path is enabled.

In one or more eleventh embodiments, further to the tenth embodiment, the system further comprises second switch circuitry coupled to the controller circuit and to the battery pack, wherein based on the second signal, the second switch circuitry is to selectively disable a second conductive path to communicate a third signal to the battery pack, wherein based on the third signal, third switch circuitry of the battery pack is to enable an output of a third voltage from the battery pack.

In one or more twelfth embodiments, further to the eleventh embodiment, the system further comprises fourth switch circuitry coupled between the voltage regulator and an output terminal of the battery charger, wherein based on the second signal, the fourth switch circuitry is to selectively disable a third conductive path, wherein the battery charger is to provide the first voltage to the voltage regulator while the third conductive path is enabled.

In one or more thirteenth embodiments, further to the tenth embodiment or the eleventh embodiment, the system further comprises second switch circuitry coupled between the voltage regulator and an output terminal of the battery charger, wherein based on the second signal, the second switch circuitry is to selectively disable a second conductive path, wherein the battery charger is to provide the first voltage to the voltage regulator while the second conductive path is enabled.

In one or more fourteenth embodiments, further to any of the tenth, eleventh, or thirteenth embodiments, the system further comprises first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

In one or more fifteenth embodiments, further to the fourteenth embodiment, the first circuitry is to delivery power to the controller circuit with one of the third voltage during the power state.

In one or more sixteenth embodiments, further to the fourteenth embodiment, the first circuitry is to receive the third voltage from a first low dropout regulator circuit of the battery pack, or the first circuitry is to receive the fourth voltage from a second low dropout regulator circuit of the voltage regulator.

In one or more seventeenth embodiments, further to any of the tenth, eleventh, or thirteenth embodiments, during the power state, a first power rail is to be enabled, and the IC die is to receive a real time clock signal which is generated based on the first power rail.

In one or more eighteenth embodiments, further to the seventeenth embodiment, during the power state, any other power rail which is to deliver power to the IC die is disabled.

In one or more nineteenth embodiments, a device comprises a battery charger to output a first voltage, a voltage regulator coupled to the battery charger, the voltage regulator to output a second voltage based on the first voltage, an integrated circuit (IC) die coupled to receive power from the voltage regulator based on the second voltage, and further to output a first signal which indicates that the IC die is able to accommodate a power state wherein the voltage regulator is disabled, a controller circuit coupled to the IC die and the voltage regulator, the controller circuit to generate, based on the first signal, a second signal to disable the voltage regulator, and a connector to receive a battery pack which is to be charged with the battery charger, first switch circuitry coupled to the controller circuit and to the connector, wherein based on the second signal, the first switch circuitry is to selectively disable a first conductive path while the battery pack is coupled to the connector, the first conductive path to communicate a third signal to the battery pack, wherein based on the third signal, second switch circuitry of the battery pack is to enable an output of a third voltage from the battery pack.

In one or more twentieth embodiments, further to the nineteenth embodiment, the device further comprises third switch circuitry coupled between the connector and an input terminal of the battery charger, wherein based on the second signal, the third switch circuitry is to selectively disable a second conductive path while the battery pack is coupled to the connector, wherein the third voltage is to be provided to the input terminal while the second conductive path is enabled.

In one or more twenty-first embodiments, further to the twentieth embodiment, the device further comprises fourth switch circuitry coupled between the voltage regulator and an output terminal of the battery charger, wherein based on the second signal, the fourth switch circuitry is to selectively disable a third conductive path, wherein the battery charger is to provide the first voltage to the voltage regulator while the third conductive path is enabled.

In one or more twenty-second embodiments, further to the nineteenth embodiment or the twentieth embodiment, the device further comprises third switch circuitry coupled between the voltage regulator and an output terminal of the battery charger, wherein based on the second signal, the third switch circuitry is to selectively disable a second conductive path, wherein the battery charger is to provide the first voltage to the voltage regulator while the second conductive path is enabled.

In one or more twenty-third embodiments, further to any of the nineteenth, twentieth, or twenty-second embodiments, the device further comprises first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

In one or more twenty-fourth embodiments, further to the twenty-third embodiment, the first circuitry is to delivery power to the controller circuit with one of the third voltage during the power state.

In one or more twenty-fifth embodiments, further to the twenty-third embodiment, the first circuitry is to receive the third voltage from a first low dropout regulator circuit of the battery pack, or the first circuitry is to receive the fourth voltage from a second low dropout regulator circuit of the voltage regulator.

In one or more twenty-sixth embodiments, further to any of the nineteenth, twentieth, or twenty-second embodiments, during the power state, a first power rail is to be enabled, and the IC die is to receive a real time clock signal which is generated based on the first power rail.

In one or more twenty-seventh embodiments, further to the twenty-sixth embodiment, during the power state, any other power rail which is to deliver power to the IC die is disabled.

Techniques and architectures for improving an efficiency of power delivery resources are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computer arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computer device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
a controller circuit to be coupled to:
a battery charger which is to output a first voltage;
a voltage regulator which is to output a second voltage based on the first voltage; and
an integrated circuit (IC) die which is to receive power from the voltage regulator based on the second voltage, and further to output a first signal which indicates that the IC die is able to accommodate a power state wherein the voltage regulator is disabled;
wherein, based on the first signal, the controller circuit to generate a second signal to disable the voltage regulator;
a connector to receive a battery pack which is to be charged with the battery charger;
first switch circuitry coupled to the controller circuit and to the connector, wherein based on the second signal, the first switch circuitry is to selectively disable a first conductive path while the battery pack is coupled to the connector, the first conductive path to communicate a third signal to the battery pack, wherein based on the third signal, second switch circuitry of the battery pack is to enable an output of a third voltage from the battery pack.

2. The device of claim 1, further comprising:
third switch circuitry coupled between the connector and an input terminal of the battery charger, wherein based on the second signal, the third switch circuitry is to selectively disable a second conductive path while the battery pack is coupled to the connector, wherein the third voltage is to be provided to the input terminal while the second conductive path is enabled.

3. The device of claim 2, further comprising:
fourth switch circuitry coupled between the voltage regulator and an output terminal of the battery charger, wherein based on the second signal, the fourth switch circuitry is to selectively disable a third conductive path, wherein the battery charger is to provide the first voltage to the voltage regulator while the third conductive path is enabled.

4. The device of claim 1, further comprising:
third switch circuitry coupled between the voltage regulator and an output terminal of the battery charger, wherein based on the second signal, the third switch circuitry is to selectively disable a second conductive path, wherein the battery charger is to provide the first voltage to the voltage regulator while the second conductive path is enabled.

5. The device of claim 1, further comprising first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

6. The device of claim 5, wherein the first circuitry is to delivery power to the controller circuit with one of the third voltage during the power state.

7. The device of claim 5, wherein:
the first circuitry is to receive the third voltage from a first low dropout regulator circuit of the battery pack; or
the first circuitry is to receive the fourth voltage from a second low dropout regulator circuit of the voltage regulator.

8. The device of claim 1, wherein, during the power state, a first power rail is to be enabled, and the IC die is to receive a real time clock signal which is generated based on the first power rail.

9. The device of claim 8, wherein, during the power state, any other power rail which is to deliver power to the IC die is disabled.

10. A system comprising:
a battery charger to output a first voltage;
a battery pack to receive a charge from the battery charger;
a voltage regulator coupled to the battery charger, the voltage regulator to output a second voltage based on the first voltage;
an integrated circuit (IC) die coupled to receive power from the voltage regulator based on the second voltage, and further to output a first signal which indicates that the IC die is able to accommodate a power state wherein the voltage regulator is disabled;
a controller circuit coupled to the IC die and the voltage regulator, the controller circuit to generate, based on the first signal, a second signal to disable the voltage regulator; and
first switch circuitry coupled between an output terminal of the battery pack and an input terminal of the battery charger, wherein based on the second signal, the first switch circuitry is to selectively disable a first conductive path, wherein a third voltage is to be provided from the battery charger to the input terminal while the first conductive path is enabled.

11. The system of claim 10, further comprising:
second switch circuitry coupled to the controller circuit and to the battery pack, wherein based on the second signal, the second switch circuitry is to selectively disable a second conductive path to communicate a third signal to the battery pack, wherein based on the third signal, third switch circuitry of the battery pack is to enable an output of a third voltage from the battery pack.

12. The system of claim 11, further comprising:
fourth switch circuitry coupled between the voltage regulator and an output terminal of the battery charger, wherein based on the second signal, the fourth switch circuitry is to selectively disable a third conductive path, wherein the battery charger is to provide the first voltage to the voltage regulator while the third conductive path is enabled.

13. The system of claim 10, further comprising:
second switch circuitry coupled between the voltage regulator and an output terminal of the battery charger, wherein based on the second signal, the second switch circuitry is to selectively disable a second conductive path, wherein the battery charger is to provide the first voltage to the voltage regulator while the second conductive path is enabled.

14. The system of claim 10, further comprising first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

15. The system of claim 10, wherein, during the power state, a first power rail is to be enabled, and the IC die is to receive a real time clock signal which is generated based on the first power rail.

16. A device comprising:
a battery charger to output a first voltage;
a voltage regulator coupled to the battery charger, the voltage regulator to output a second voltage based on the first voltage;
an integrated circuit (IC) die coupled to receive power from the voltage regulator based on the second voltage, and further to output a first signal which indicates that the IC die is able to accommodate a power state wherein the voltage regulator is disabled;
a controller circuit coupled to the IC die and the voltage regulator, the controller circuit to generate, based on the first signal, a second signal to disable the voltage regulator; and
a connector to receive a battery pack which is to be charged with the battery charger;
first switch circuitry coupled to the controller circuit and to the connector, wherein based on the second signal, the first switch circuitry is to selectively disable a first conductive path while the battery pack is coupled to the connector, the first conductive path to communicate a third signal to the battery pack, wherein based on the third signal, second switch circuitry of the battery pack is to enable an output of a third voltage from the battery pack.

17. The device of claim 16, further comprising:
third switch circuitry coupled between the connector and an input terminal of the battery charger, wherein based on the second signal, the third switch circuitry is to selectively disable a second conductive path while the battery pack is coupled to the connector, wherein the third voltage is to be provided to the input terminal while the second conductive path is enabled.

18. The device of claim 16, further comprising:
third switch circuitry coupled between the voltage regulator and an output terminal of the battery charger, wherein based on the second signal, the third switch circuitry is to selectively disable a second conductive path, wherein the battery charger is to provide the first voltage to the voltage regulator while the second conductive path is enabled.

19. The device of claim 16, further comprising first circuitry coupled to receive the third voltage via a path of the battery charger which is independent of the second switch circuitry, the first circuitry further coupled to receive from the voltage regulator a fourth voltage which is based on the first voltage, the first circuitry to delivery power to the controller circuit with one of the third voltage or the fourth voltage.

20. The device of claim 19, wherein the first circuitry is to delivery power to the controller circuit with one of the third voltage during the power state.
